(19) United States
(12) Patent Application Publication
(10) Pub. No.: US 2017/0243247 A1
(43) Pub. Date: Aug. 24, 2017

(54) PUSH NOTIFICATIONS FOR PRICE CHANGE ALERTS

(71) Applicant: Vizury Interactive Solutions Private Limited, Bangalore (IN)

(72) Inventors: Shiju Mathew, Tiruvalla (IN); Prasanna Arunachalam, Royapuram (IN); Anurag Bhoumick, Allahabad (IN); Chethan Panduranga, Bangalore (IN)

(21) Appl. No.: 15/097,673

(22) Filed: Apr. 13, 2016

(30) Foreign Application Priority Data
Feb. 24, 2016 (IN) 201641006465

(51) Int. Cl. G06Q 30/02; H04L 29/08

(52) U.S. Cl. CPC G06Q 30/0255; G06Q 30/0267; H04L 67/26

(57) ABSTRACT

Embodiments herein disclose a computer-implemented method for notifying about a price change. The method includes receiving information about a product browsed in a client application on a mobile device. Further, the method includes detecting a change in price of the product. Further, the method includes determining whether the change in price exceeds a price threshold. Furthermore, the method includes sending a push notification to the mobile device based on determining that the change in price exceeds the price threshold.

### TECHNICAL FIELD

The present application relates to notification systems, and more particularly to a mechanism for notifying about a price change to a user via a push notification. The present application is based on and claims priority from an Indian Application Number 201641006465 filed on 24 Feb. 2016, the disclosure of which is hereby incorporated by reference.

### BACKGROUND

E-commerce is continually increasing in popularity and has evolved with the growth in technology. A user visits an e-commerce site to compare product features and their prices. However, the percentage of e-commerce users who actually buy a product after viewing it online is very low. The e-commerce user is mainly influenced by the sales price offered for a particular product. In cases where the sales price offered is appropriate, the e-commerce user will end up buying the product in the e-commerce site.

One way of increasing business opportunities in the e-commerce, a service provider sends a price drop alert to the user. The price drop alert creates a lasting positive impression on the user. Conventional systems and methods provide the price drop alert to the user based on a subscription. The user has to manually locate and subscribe to receive the price drop notification which may be cumbersome and time consuming for the user. The price drop notification is sent to the subscribed user without considering any parameters which result in unnecessary disturbance to the user or the user may find the price drop notification as out of interest which may decrease the overall user experience. Further, targeting or retargeting the user, for sending such notifications, from web to app or in-application client product involves significant challenges. Thus, it is desired to address the above mentioned disadvantages or shortcomings or at least provide a useful alternative.

### SUMMARY

The principal object of the embodiments herein is to provide a method for notifying about a price change via a push notification.

Another object of the embodiments herein is to provide a mechanism for receiving information about a product browsed in a client application on a mobile device.

Another object of the embodiments herein is to provide a mechanism for detecting a change in price of a product.

Another object of the embodiments herein is to provide a mechanism for determining whether a change in price exceeds a price threshold.

Another object of the embodiments herein is to provide a mechanism for sending a push notification to a mobile device.

Accordingly embodiments herein disclose a computer-implemented method for notifying about a price change. The method includes receiving, by a controller unit, information about a product browsed in a client application on a mobile device. Further, the method includes detecting, by the controller unit, a change in price of the product. Further, the method includes determining, by the controller unit, whether the change in price exceeds a price threshold. Furthermore, the method includes sending, by the controller unit, a push notification to the mobile device based on determining that the change in price exceeds the price threshold.

Embodiments herein disclose a server for notifying about a price change. The server includes a controller unit configured to receive information about a product browsed in a client application on a mobile device. Further, the controller unit is configured to detect the change in price of the product. Further, the controller unit is configured to determine whether the change in price exceeds a price threshold. Furthermore, the controller unit is configured to send a push notification to the mobile device in response to determining that the change in price exceeds the price threshold.

Accordingly the embodiment herein provides a computer program product including a computer executable program code recorded on a computer readable non-transitory storage medium. The computer executable program code when executed causing the actions including receiving, by a controller unit, information about a product browsed in a client application on a mobile device. The computer executable program code when executed causing the actions including detecting, by the controller unit, a change in price of the product. The computer executable program code when executed causing the actions including determining, by the controller unit, whether the change in price exceeds a price threshold. The computer executable program code when executed causing the actions including ending, by the controller unit, a push notification to the mobile device in response to determining that the change in price exceeds the price threshold.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 illustrates generally, among other things, a high level overview of a system for notifying about a price change via a push notification, according to an embodiment as disclosed herein;

FIG. 2 illustrates various units of a server, according to an embodiment as disclosed herein;

FIG. 3 illustrates various units of a mobile device, according to an embodiment as disclosed herein;

FIG. 4 is an example scenario in which a Google Cloud Messaging (GCM) server sends a push notification to a mobile device, according to an embodiment as disclosed herein;

FIG. 5 illustrates various units of a controller unit operated with a GCM server to facilitate a push notification to a mobile device, according to an embodiment as disclosed herein;

FIG. 6a and FIG. 6b illustrate example scenarios in which a mobile device displays a push notification received from a server, according to an embodiment as disclosed herein;

FIG. 7 is a flow diagram illustrating a method for notifying about a price change via a push notification, according to an embodiment as disclosed herein; and

FIG. 8 illustrates a computing environment implementing a mechanism for notifying about a price change via a push notification, according to an embodiment as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Throughout the description, the terms user and customer are used interchangeably.

The embodiments herein achieve a computer-implemented method and a server for notifying about a price change via a push notification. The method includes receiving, by a controller unit, information about a product browsed in a client application on a mobile device. Further, the method includes detecting, by the controller unit, a change in price of the product. Further, the method includes determining, by the controller unit, whether the change in price exceeds a price threshold. Furthermore, the method includes sending, by the controller unit, a push notification to the mobile device based on determining that the change in price exceeds the price threshold.

In an embodiment, the price threshold is dynamically defined by a service provider of the product. The service provider is associated with the client application.

In an embodiment, the server comprises a message builder to build the push notification.

Unlike the conventional systems and methods, a push notification about a price change is sent to the user without any subscription. More particularly, when targeting or retargeting the user, for sending price change alerts, from web to app or in-application products browsed by the user. Further, instead of directly sending a notification to a subscribed user without considering any parameters, the proposed system and method can be used to implement different rules defined by one or more rule engines of the services provider to share only those price changes alerts which is of interest to the user thereby increasing the overall user experience.

A proprietary push notification system can be used to target or retarget the products browsed by a user in a mobile phone. For example, the Android phone system which targets or retargets the dropped-off users of any mobile App when the price of the product they have seen on the App drops or increased. The user is then retargeted with customized push notification which shows them the products they had seen earlier, together with the dropped price. Further, when the user clicks on the customized push notification, the user is traversed to the exact product's deep-link inside the App to make their purchase easier.

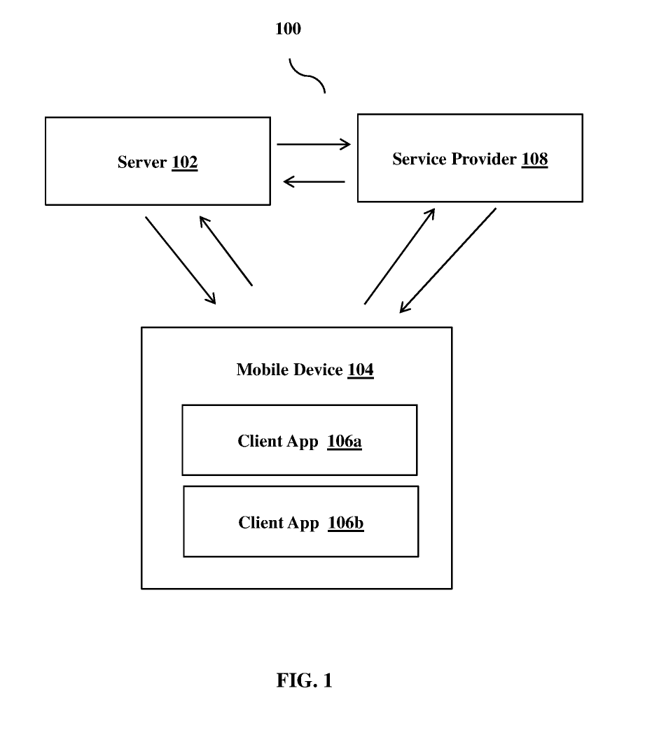

Referring now to the drawings and more particularly to FIGS. 1 through 8, where similar reference characters denote corresponding features consistently throughout the figure, there are shown preferred embodiments.

FIG. 1 illustrates generally, among other things, a high level overview of a system 100 for notifying about a price change via a push notification, according to an embodiment as disclosed herein. In an embodiment, the system 100 includes a server 102, a mobile device 104, one or more client apps 106a and 106b (hereafter referred as the client app is 106), and a service provider 108. The mobile device 104 can be, for example but not limited to, a smart phone, a tablet, a laptop, a cellular phone, a personal digital assistant (PDA), a digital picture frame, or the like. In an embodiment, the client app 106 is installed by a user based on the user interest. In an embodiment, the client application is a native application installed by Original Equipment Manufacturer (OEM) in the mobile device 104. The server 102, the mobile device 104, and the service provider 108 are communicated over a network (not shown). The network can be a data network such as an Internet and may also comprise various public or private networks, such as third generation (3G) network, Long-Term Evolution (LTE) or other wireless data networks, virtual private networks (VPNs), or the like.

In an embodiment, the server 102 is configured to receive information about a product browsed in the client app 106 on the mobile device 104. The product is an item offered for sale. The product can be a service, an item, or the like. In an embodiment, based on received information, the server 102 is configured to identify the product that the customer is visited on a repeated basis (It is also called as products of interest) in the client app 106 on the mobile device 104. As used herein, the term “products of interest” as it relates to the user, means products that the user is likely to purchase in the future. The products of interest can include products that the customer recently visited. In general, the product of interest is the product that may hold some particular importance to the user. In an embodiment, based on received information, the server 102 is configured to identify that the user is likely to purchase the product in the future based on the user's purchasing habits.

In an embodiment, the server 102 is configured to identify the product to the user by analyzing the customer's recent shopping behavior and identifying the product that the user has recently visited or has purchased multiple times in prior shopping trips. In an embodiment, the server 102 is configured to identify the product that is similar or complementary to recently-visited products. In an embodiment, the server 102 is configured to evaluate a wide variety of the user data, such as seasonal shopping behaviors, customer demographic data, and the like to identify the product of interest to the user. Other known techniques for identifying the products of interest also fall under the scope of this disclosure.

Based on the identified product, the server 102 is configured to detect a change in price of the product. In an embodiment, the change in price is also called as price reduction. In an embodiment, the change in price is also called as price increased value. After detecting the change in price of the product, the server 102 is configured to determine whether the change in price exceeds a price threshold. In an embodiment, the price threshold is dynamically defined by the service provider 108 of the product. The service provider 108 is associated with the client application 106.

If the change in price exceeds the price threshold, the server 102 is configured to send the push notification to the mobile device 104. In an embodiment, the push notification can be presented to the user on the mobile device 104, and the push notification includes the price reduction level, price offer, valid date, or any other product related information. In an embodiment, the push notification may include the product information, including product Universal Product Code (UPC) numbers or other product codes, the price variation for the product, the date and time, and other relevant information about the product. The product information may be represented by a hyperlink, a unique numerical code, or any other format.

In an embodiment, the push notification provides a basic level of information regarding the price reduction on the product of interest and the customer's projected savings. In an embodiment, the push notification may give the user the option to view additional details regarding the price reduction or price increases. In an embodiment, the server 102 is configured to provide split testing with different push notification messages to determine which push notifications are most effective to the user. An existing technique can be used to select the most effective push notifications based on the user information.

In an embodiment, the server 102 is configured to identify numerous products of interest but selectively display only the notifications deemed to create the strongest impact on the user. The determination of strongest impact can be based on the following factors that are provided as examples: how often that product of interest was visited by the user, how often the user purchases related products that are complementary to that product of interest, how much the user will save per purchase, and how much the projected savings is for the user.

Consider a scenario, in which a Flipkart® application is installed in the smartphone by the user. If the user interests to buy a watch over the Flipkart® application then, the server 102 receives the watch information browsed in the Flipkart® application on the smartphone. Based on the watch information browsed in the Flipkart® application, the server 102 monitors any change in price of the watch in a Flipkart® server. In an example, the change in price can be the price reduction. In another example, the change in price can be the price increased value. After monitoring the change in price of the watch in the Flipkart® server, the server 102 sends the push notification to the smartphone, when the change in price exceeds the price threshold. The price threshold is dynamically defined by the Flipkart® server.

Consider a scenario, an Amazon® application is installed in the smartphone by the user. If the user interests to buy the laptop over the Amazon® application then, the server 102 receives the laptop related information browsed in the Amazon® application on the smartphone. Based on the laptop related information browsed in the Amazon® application, the server 102 monitors any change in price of the laptop in an Amazon® server. In an example, the change in price can be the price reduction. In another example, the change in price can be the price increased value. In case any price change in the laptop related product (i.e. the user interested to buy in the model A laptop, but the price change is identified for the model B laptop). After monitoring the change in price of the model B laptop in the Amazon® server, the server 102 sends the push notification to the smartphone, when the change in price exceeds the price threshold. The price threshold is dynamically defined by the Amazon® server.

In an example, the server 102 sends the combined push notifications (i.e., various price changes related to user interested products) to the mobile device 104, when the change in price exceeds the price threshold.

The FIG. 1 show the limited overview of the system 100 but, it is to be understood that other embodiments are not limited thereto. Further, the system 100 can include any number of server 102, the mobile device 104, and the service provider 108. Further, the system 100 includes any number of hardware or software components communicating with each other. By way of illustration, both an application running on a device and the device itself can be a component.

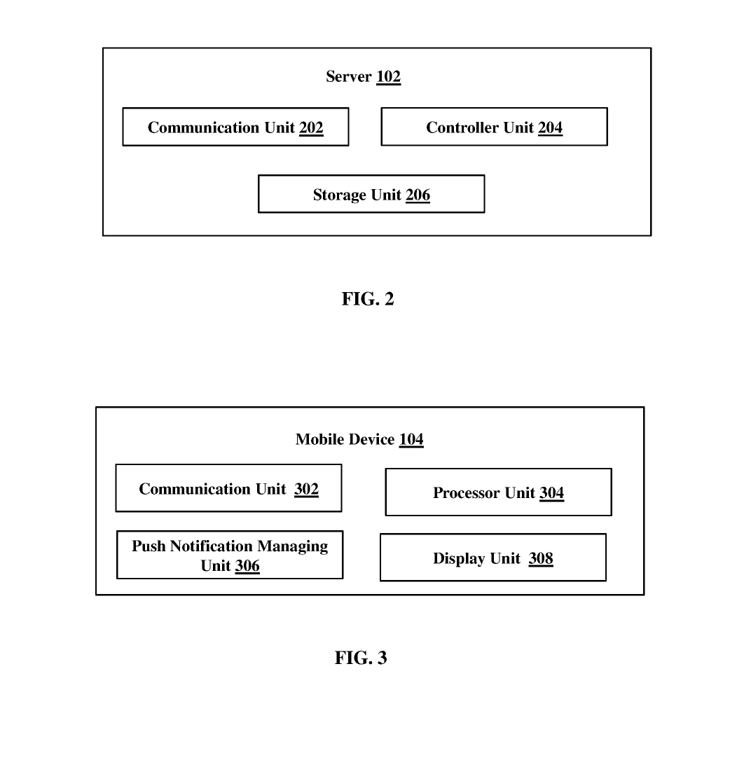

FIG. 2 illustrates various units of the server 102, according to an embodiment as disclosed herein. In an embodiment, the server 102 includes a communication unit 202, a controller unit 204, and a storage unit 206. The communication unit 202 is configured to receive information about the product browsed in the client application 106 on the mobile device 104. Based on received information, the controller unit 204 is configured to identify the product that the user is visited on the repeated basis. In an embodiment, based on received information, the controller unit 204 is configured to identify that the user is likely to purchase the product in the future based on the user's purchasing habits.

In an embodiment, the controller unit 204 is configured to identify the product to the user by analyzing the customer's recent shopping behavior and identifying the product that the user has recently visited or has purchased multiple times in prior shopping trips. In an embodiment, the controller unit 204 is configured to identify the product that is similar or complementary to recently-visited products. In an embodiment, the controller unit 204 is configured to evaluate the wide variety of the user data, such as seasonal shopping behaviors, customer demographic data, and the like to identify the product of interest to the user.

Based on the identified product, the controller unit 204 is configured to detect the change in price of the product. After detecting the change in price of the product, the controller unit 204 is configured to determine whether the change in price exceeds the price threshold. If the change in price exceeds the price threshold, the communication unit 202 is configured to send the push notification to the mobile device 104. In an embodiment, the communication unit 202 is configured for communicating internally between internal units and with external devices via one or more the networks.

In an embodiment, the storage unit 206 is configured to maintain a record of user visit related to the product. Further, the storage unit 206 is configured to maintain on updating information about the products user has visited. Further, the storage unit 206 is configured to store the most recent price of that product queried by the user. The storage unit 206 may include one or more computer-readable storage media. The storage unit 206 may include non-volatile storage elements. Examples of such non-volatile storage elements may include magnetic hard disc, optical discs, floppy discs, flash memories, or forms of electrically programmable memories (EPROM) or electrically erasable and programmable (EEPROM) memories. In addition, the storage unit 206 may, in some examples, be considered a non-transitory storage medium. The term “non-transitory” may indicate that the storage medium is not embodied in a carrier wave or a propagated signal. However, the term “non-transitory” should not be interpreted that the storage unit 206 is non-movable. In some examples, the storage unit 206 can be configured to store larger amounts of information than a memory. In certain examples, a non-transitory storage medium may store data that can, over time, change (e.g., in Random Access Memory (RAM) or cache).

Although the FIG. 2 shows exemplary units of the server 102 but it is to be understood that other embodiments are not limited thereon. In other embodiments, the server 102 may include less or more number of units. Further, the labels or names of the units are used only for illustrative purpose and does not limit the scope of the invention. One or more units can be combined together to perform same or substantially similar function in the server 102.

FIG. 3 illustrates various units of the mobile device 104, according to an embodiment as disclosed herein. In an embodiment, the mobile device 104 includes a communication unit 302, a processor unit 304, a push notification managing unit 306, and a display unit 308. The communication unit 302 is configured to receive the change in price in the form of push notification from the server 102. After receiving the push notification from the server 102, the processor unit 304 is configured to process the push notification in the mobile device 104. The process includes a security level analysis, changing the push notification format in the mobile device accepting level, or the like. The push notification managing unit 306 is configured to manage the push notification based on the user settings. In an example, if the user sets only prices reduction notification then, the push notification managing unit 306 only allows the prices reduction notification to the user.

The display unit 308 is configured to display the push notification to the user on the mobile device 104. In an embodiment, the push notification includes the price reduction level, the price offer, the valid date, or any other product related information. In an embodiment, the push notification includes the product information, including product UPC numbers or other product codes, the price for the product, the date and time, and other relevant information about the product. The product information may be represented by the hyperlink, the unique numerical code, or any other format.

In an embodiment, the push notification provides the basic level of information regarding the price reduction or prices increases on the product of interest and the uses projected savings. Further, the push notification offers the customer the option to view additional details regarding the price reduction.

Although the FIG. 3 shows exemplary units of the mobile device 104 but it is to be understood that other embodiments are not limited thereon. In other embodiments, the mobile device 104 may include less or more number of units. Further, the labels or names of the units are used only for illustrative purpose and does not limit the scope of the invention. One or more units can be combined together to perform same or substantially similar function in the mobile device 104.

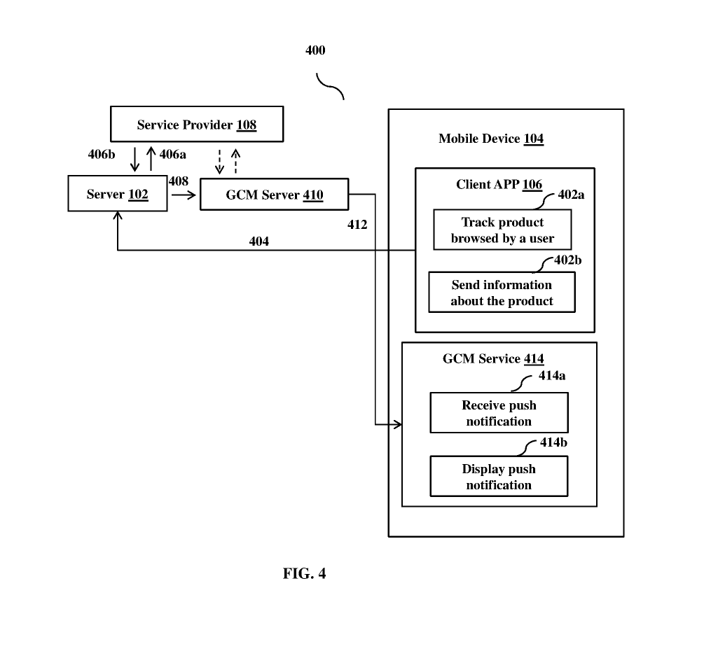

FIG. 4 is an example scenario in which a Google Cloud Messaging (GCM) server 410 sends the push notification to the mobile device 104, according to an embodiment as disclosed herein. The GCM server 410 acts as a central entity among the server 102, the mobile device 104, and the service provider 108. The GCM server 410 provides a service that enables a client apps developer to send data from the service provider 108 to Android applications executed in the mobile device 104. Further, the GCM server 410 provides a simple, lightweight mechanism such that the mobile device 104 can use to tell the client app 106 to contact the server 102 directly to fetch updated application from the server provider 108. Further, the GCM server 410 provides a service that handles all aspects of enqueuing of messages and delivery to a target application running on the mobile device 104.

Consider a scenario, where the client app 106 is installed in the mobile device 104. The client app 106 tracks (402a) the information related to the product browsed by the user interest. The client app 106 sends (402b) the product related information to the server 102. The server 102 sends (406a) the product related information to the service provider 108. The service provider 108 sends (406b) the product related information to the server 102. In an embodiment, the service provider 108 communicates with the GCM server 410 over the network (not shown). The server 102 is also communicated with the GCM server 410 over the network (not shown). Based on the product related information received from the service provider 108, the server 102 detects the change in price of the product. The change in price information is already explained in conjunction with the FIG. 1. The server 102 sends (408) the change in price of the product information to the GCM server 410. The GCM server 410 sends (412) the change in price of the product information in the form of push notification (i.e., GCM service) to the mobile device 104. The mobile device 104 receives (414a) the push notification from the GCM server 410. After receiving the push notification from the GCM server 410, the mobile device 104 displays (414b) the push notification.

In another example, an Apple® Push Notification Service (APNs), BlackBerry® Push Service or the like are acted as central entity among the server 102, the mobile device 104, and the service provider 108 and sends the push notification to the mobile device 104.

In an embodiment, the system 100 is powered by a full-fledged Android software development kit (SDK) which needs to be deployed inside the client app 106 in order for it to be able to capture all the in-App events together with the behavior data mapped to each and every mobile device identification (ID). The system 100 also captures the Google Cloud Messaging (GCM) ID of every user and then packages and sends device ID, GCM ID, in-App behavior data to the controller unit 202 which capture and store this data for further use.

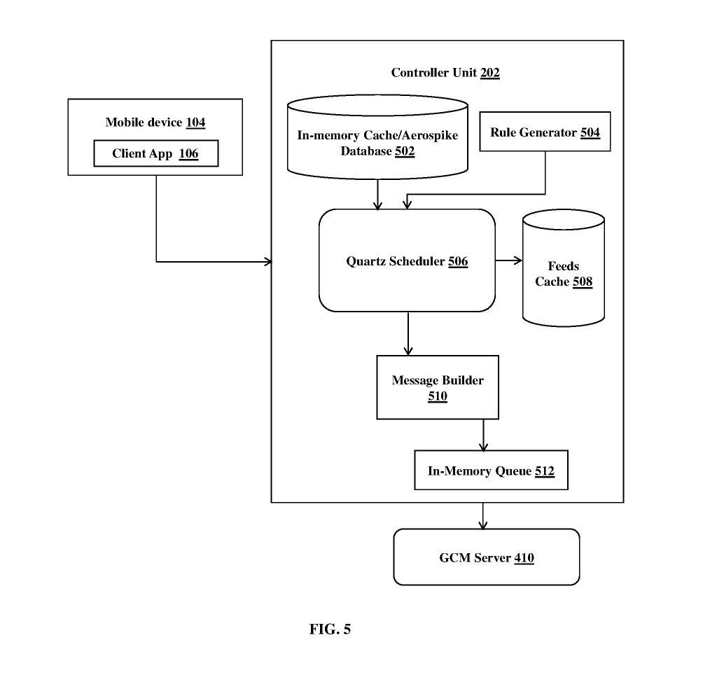

FIG. 5 illustrates various units of the controller unit 202 operated with the GCM server 404 to facilitate the push notification to the mobile device 104, according to an embodiment as disclosed herein. The client app 106 is installed in the mobile device 102. The client app 106 tracks the information related to the product browsed by the user interest. The client app 106 sends the product related information to the controller unit 202 of the server 102. In an embodiment, the controller unit 202 includes an In-memory cache/Aerospike database 502, a rule generator 504, a quartz scheduler 506, a feeds cache 508, a message builder 510, and an in-memory queue 512.

The In-memory cache/Aerospike database 502 is configured to maintain the record of user visit related to the product. Further, the In-memory cache/Aerospike database 502 is configured to maintain on updating information about the product user has visited. The In-memory cache/Aerospike database 502 is configured to store the most recent price of that product queried by the user. The rule generator 504 is configured to periodically generate the rules based on the user requirements. Based on generating the rules, the quartz scheduler 506 is configured to poll the rule generator 504 periodically to check which all rules are valid. The different rules can be set by the service provider 108 depending on what % of price drop or price increase should actually trigger the push notification. Based on that, the quartz scheduler 506 is configured to filter out segments of users who are eligible to be sent the push notification in that schedule. The quartz scheduler 506 is configured to communicate with the feed cache 508 to replace the price text with dynamic content and image of the product. The feed cache 508 is configured to send the price text along with dynamic content and image of the product to the message builder module 510. The message builder 510 is configured to build the price text along with dynamic content and image of the product in the required format and pushes it to the in-Memory queue 512 from where the service keeps picking up messages to be sent to the GCM server 410 for the retargeted customized push notifications to be sent to the user of the mobile device 104.

In an embodiment, the product codes and data for identified product of interest that have recently-reduced prices are transmitted to the GCM server 410. The GCM server 410 is adapted to interface among the service provider 108, the server 102, and the mobile device 104. The GCM server 410 sends the push notification to the user related to the change in price. In an embodiment, the GCM server 410 provides the change in price push notification to the mobile device 104 by presenting information in conjunction with presentment of an electronic receipt that is displayed via the customer app 106. In an embodiment, the push notification is sent to the mobile device 104 at a browsing time.

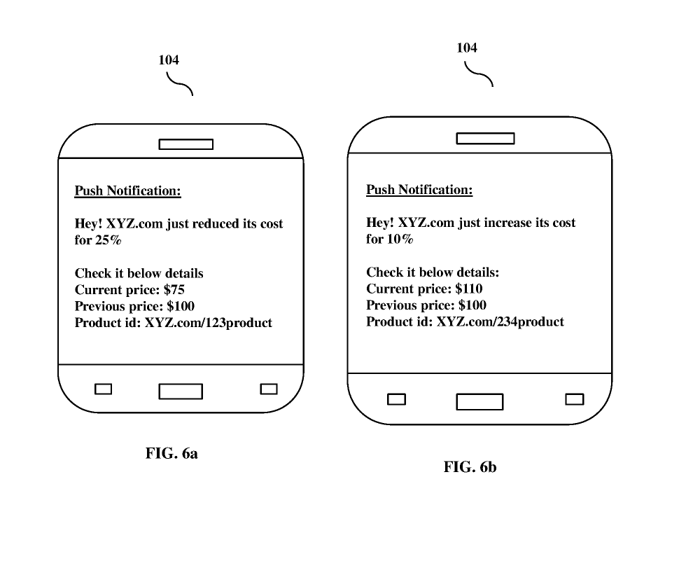

In an embodiment, the mobile device 104 receives the push notification related to the price decreases from the server 102. The mobile device 104 displays the price decreases push notification as shown in the FIG. 6a.

In an embodiment, the mobile device 104 receives the push notification related to the price increases from the server 102. The mobile device 104 displays the price increases push notification as shown in the FIG. 6b.

In an embodiment, the GCM server 410 can be adapted to provide additional marketing material on the display unit 308 of the mobile device 104, which marketing material is related to the product being described or other products that are identified as products of interest to the user. In an embodiment, the push notification includes a “call to action”. The “call to action” can include a link for the user to click for more information or the like. The “call to action” can be used to test the effectiveness of the push notification.

In an embodiment, the push notification selectively indicates a percentage savings rather than an absolute money value. The server 102 is configured to determine whether the notification indicating an absolute money value or a notification indicating a percentage is more impactful to the user. Such the determination may be made based on an understanding of human psychology and a consideration of how a typical user is affected by the push notification. In an example, the push notification that the product is less expensive by $5 may carry more impact for the user than the notification that the same product is 7% less expensive, as 7% may be understood by the user to be a low price reduction amount. On the other hand, the push notification that the product is 50% cheaper may carry more impact than a notification that the same product is $10 less expensive, as 50% may be interpreted as a relatively high price reduction value. In an embodiment, an impact threshold is selectively put in place to restrict presentment of price reduction notifications to only those deemed to provide a sufficient level of impact to the user. Thus, the system 100 may, at times, present no notifications of price reductions because no price reductions were significant enough to be shown to the user. In an embodiment, the push notification can be set for the user based on the user settings.

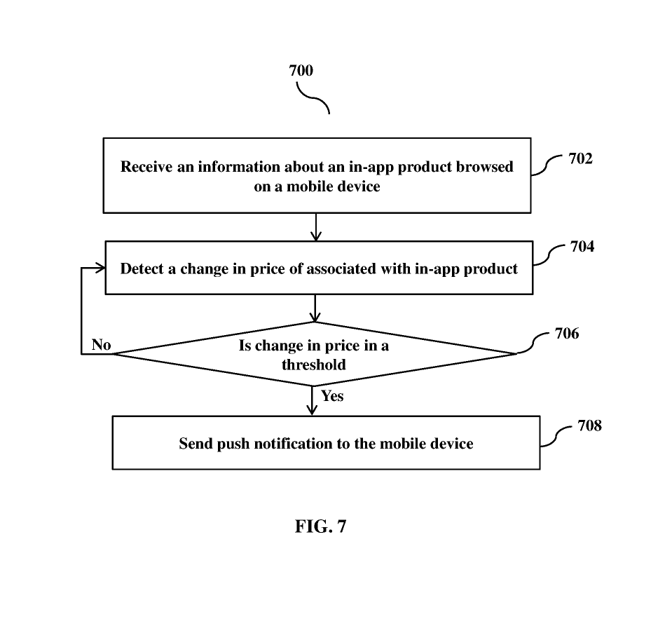

FIG. 7 is a flow diagram illustrating the method 700 for notifying about the price change, according to an embodiment as disclosed herein. The sequence of steps (702 to 708) can be performed by using the controller unit 202. The controller unit 202 is operated with a microcontroller, a microprocessor, or any computer readable storage medium. At step 702, the method 700 includes receiving information about the product browsed in the client application 106 on the mobile device 104. At step 704, the method 700 includes detecting the change in price of the product. In an embodiment, the change in price can be a price reduction. In an embodiment, the change in price can be a price increases. At step 706, the method 700 includes determining whether the change in price exceeds the price threshold. In an embodiment, the price threshold is dynamically defined by the service provider 108 of the product. The service provider 108 is associated with the client application 106. If the change in price exceeds the price threshold then, at step 708, the method 700 includes sending the push notification to the mobile device 106. If the change in price does not exceed the price threshold then, at step 704, the method 700 includes detecting the change in price of the product.

The various actions, acts, blocks, steps, or the like in the method 700 may be performed in the order presented, in a different order or simultaneously. Further, in some embodiments, some of the actions, acts, blocks, steps, or the like may be omitted, added, modified, skipped, or the like without departing from the scope of the invention.

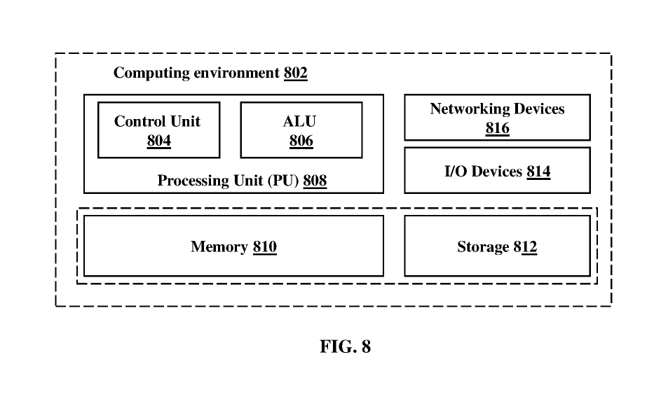

FIG. 8 illustrates a computing environment 802 implementing a mechanism for notifying about the price change via the push notification, according to an embodiment as disclosed herein. As depicted in the figure, the computing environment 802 comprises at least one processing unit 808 that is equipped with a control unit 804, an Arithmetic Logic Unit (ALU) 806, a memory 810, a storage unit 812, a plurality of networking devices 816 and a plurality Input output (I/O) devices 814. The processing unit 808 is responsible for processing the instructions of the technique. The processing unit 808 receives commands from the control unit 804 in order to perform its processing. Further, any logical and arithmetic operations involved in the execution of the instructions are computed with the help of the ALU 806.

The overall computing environment 802 can be composed of multiple homogeneous or heterogeneous cores, multiple CPUs of different kinds, special media and other accelerators. The processing unit 808 is responsible for processing the instructions of the technique. Further, the plurality of processing units 804 may be located on a single chip or over multiple chips.

The technique comprising of instructions and codes required for the implementation are stored in either the memory unit 810 or the storage 812 or both. At the time of execution, the instructions may be fetched from the corresponding memory 810 or storage 812, and executed by the processing unit 808.

In case of any hardware implementations various networking devices 816 or external I/O devices 814 may be connected to the computing environment 802 to support the implementation through the networking unit and the I/O device unit.

The embodiments disclosed herein can be implemented through at least one software program running on at least one hardware device and performing network management functions to control the elements. The elements shown in the FIGS. 1 to 8 include blocks which can be at least one of a hardware device, or a combination of hardware device and software module.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A computer-implemented method for notifying about a price change, the method comprising:
receiving, by a controller unit, information about product browsed in a client application on a mobile device;
detecting, by said controller unit, a change in price of said product;
determining, by said controller unit, whether said change in price exceeds a price threshold; and
sending, by said controller unit, a push notification to said mobile device in response to determining that said change in price exceeds said price threshold.

2. The method of claim 1, wherein said price threshold is dynamically defined by a service provider of said product, wherein said service provider is associated with said client application.

3. A server for notifying about a price change, the server comprising:
a controller unit configured to:
receive an information about a product browsed in a client application on a mobile device;
detect a change in price of said product;
determine whether said change in price exceeds a price threshold; and
send a push notification to said mobile device in response to determining that said change in price exceeds said price threshold.

4. The server of claim 3, wherein said price threshold is dynamically defined by a service provider of said product, wherein said service provider is associated with said client application.

5. The server of claim 3, wherein said server comprises a message builder to build said push notification.

6. A computer program product comprising a computer executable program code recorded on a computer readable non-transitory storage medium, wherein said computer executable program code when executed causing the actions including:
receiving, by a controller unit, information about a product browsed in a client application on a mobile device;
detecting, by said controller unit, a change in price of said product;
determining, by said controller unit, whether said change in price exceeds a price threshold; and
sending, by said controller unit, a push notification to said mobile device in response to determining that said change in price exceeds said price threshold.

7. The computer program product of claim 6, wherein said price threshold is dynamically defined by a service provider of said product, wherein said service provider is associated with said client application.
